(19) United States
(12) Patent Application Publication
(10) Pub. No.: US 2017/0050315 A1
(43) Pub. Date: Feb. 23, 2017

(54) Method And Facility For Automatically Gripping An Object

(71) Applicant: SILEANE, Saint Etienne (FR)

(72) Inventors: Herve Henry, Saint-Cyr-Les-Vignes (FR); Florian Sella, Chalain Le Comtal (FR); Romain Bregier, Janneyrias (FR)

(21) Appl. No.: 15/306,715

(22) PCT Filed: Apr. 23, 2015
(86) PCT No.: PCT/FR2015/051113

§ 371 Date: Oct. 25, 2016

(30) Foreign Application Priority Data
Apr. 25, 2014 (FR) 1453725

(51) Int. Cl. B25J 9/16; B25J 15/00; B25J 15/06

(52) U.S. Cl. CPC B25J 9/1612; B25J 9/1697; B25J 9/1664; B25J 15/0616; B25J 15/0028; G05B 2219/39473; G05B 2219/39536; G05B 2219/39553; G05B 2219/40053

(57) ABSTRACT

A method of using a polyarticulated system associated with a vision system for automatically picking up an article situated in a zone suitable for receiving at least one article, the polyarticulated system including at least one pick-up member suitable for taking hold of an article via at least one specific zone of the article. In accordance with the invention, the method includes at least the steps of: taking an image of the article-receiving zone; processing the information resulting from the 3D image and identifying all of the specific zones that are present on the articles to be taken hold of, and that are compatible with the pick-up member(s); locating the identified compatible specific zone(s); choosing one of the located compatible specific zones and automatically defining a pick path; and taking hold of the corresponding article along the defined path.

### FIELD OF THE INVENTION

The present invention relates to the technical sector of manipulating articles by using a polyarticulated system. The expression “polyarticulated system” is used to mean a robotized system having six axes, for example.

The invention relates more particularly to a method of automatically picking up an article by using a polyarticulated system associated with a vision system.

The invention is advantageously applicable when, for example, it is desired to sort articles that are oriented randomly and that are conveyed one after another, or indeed when, for example, it is desired to extract articles one-by-one from a loose pile. The expression “loose pile” is used to mean a heap or a cluster of articles that may be different or identical, and that are oriented randomly in a volume.

In general manner, the invention relates to all applications in which it is necessary to take hold of an article via a polyarticulated system.

### BACKGROUND OF THE INVENTION

A method of controlling a robot for moving at least one article disposed on a support in a three-dimensional (3D) space is known from the state of the art, and in particular from Patent Application FR 2 987 685. That method comprises, in particular, the following steps:
acquiring at least two two-dimensional (2D) images of the 3D space;
segmenting each previously acquired 2D image, for the purpose of extracting at least one 2D geometric primitive from each 2D image;
searching for matches between the 2D geometric primitives extracted from distinct 2D images;
computing the coordinates of a 3D geometric primitive contained in the 3D space for each group of matching geometric primitives 2D;
associating each 3D geometric primitive with a known article;
searching for the position and the orientation in the 3D space of each known article with which at least one 3D geometric primitive has been associated; and
using a robot to move at least one of the known articles.

Thus, that method offers the possibility of detecting, of locating, and of orienting the articles in a 3D space.

However, that method suffers from the drawback of not adapting to cope with any type of article to be moved. That method functions only with articles that are already known and identified by learning software. That method cannot be applied when it is desired, for example, to isolate, one-by-one, unknown articles of different types coming from a loose pile. Such an application consists, for example, in performing a sorting operation on a heap of articles.

### SUMMARY OF THE INVENTION

An object of the invention is to mitigate the above-mentioned drawbacks, and thus to provide a method of automatically picking up an unknown article, without any prior learning of the article, and without any prior learning of the pick path along which said article should be taken hold of.

An object of the invention is also to provide a method that, for example, makes it possible to sort articles that are oriented randomly and that are conveyed one after another, or indeed to extract articles one-by-one from a loose pile.

To these ends, the invention provides a method of using a polyarticulated system associated with a vision system for automatically picking up an unknown article situated in a zone suitable for receiving at least one article. The polyarticulated system includes at least one pick-up member suitable for taking hold of an article via at least one specific zone of said article, and the method is remarkable in that it comprises at least the steps consisting in:
taking an image of the article-receiving zone by means of the vision system;
processing the information resulting from the image and identifying all of the specific zones that are present on the articles to be taken hold of, and that are compatible with the pick-up member(s);
locating, in position and in orientation, the identified compatible specific zone(s);
choosing one of the located compatible specific zones and automatically defining a pick path along which the corresponding pick-up member should take hold of the corresponding article via the chosen compatible specific zone; and
taking hold of the corresponding article along the defined path.

Thus, the automatic pick-up method does not require any learning of the article to be taken hold of. The article can be of any sort; it suffices merely for a specific zone of the article to be detected, and for that zone to be compatible with the pick-up member of the polyarticulated system for the article to be taken hold of via said specific zone.

The article taken hold of can then be handled or processed in any desired manner. For example, if the method is incorporated into a sorting operation, it can be placed in a specific article-receiving tray or bin.

The invention relates to all applications in which it is necessary to take hold of an article via a polyarticulated system.

In order to sort articles that are oriented randomly and that are conveyed one after another, or indeed in order to extract articles one-by-one from a loose pile, it suffices to repeat the method as many times as necessary. Each time an article has been taken hold of, the method loops back to the first step that consists in taking an image of the article-receiving zone. In this way, the method adapts in real time to the article-receiving zone. In other words, an article to be taken hold of that has been moved by the preceding article being taken hold of will nevertheless be located and taken hold of.

The method is also advantageous in that it does not seek to recognize an article but rather to recognize specific pick zones on the articles to be taken hold of. In this way, articles of various sizes, shapes, or materials can be taken hold of using the same pick-up member, and without requiring the article to be learnt. It suffices merely for the articles to be taken hold of to have specific zones compatible with said pick-up member.

Given that the compatible specific zone is located, in position and orientation, the method does not need any learning of the pick path along which the corresponding article should be taken hold of. The pick path is computed in real time, and for each article to be taken hold of. The method then makes it possible to perform pick and place operations very rapidly for picking and placing unknown articles.

Advantageously, the method is intelligent, and the step consisting in choosing one of the located compatible specific zones consists in weighting each identified zone with a coefficient that is a function of the probabilities of the zone being successfully taken hold of by the corresponding pick-up member, and in choosing the zone that has the highest probabilities of being successfully taken hold of.

The weighting coefficient may be a function of any type of parameter, such as, for example, the distance between the located compatible specific zone and the corresponding pick-up member. The weighting coefficient may also be computed as a function of the orientation of the zone to be taken hold of. The probabilities of success depend on the pick-up member used.

In order to increase the speed of the pick-up method, the step consisting in defining a pick path for the pick-up member consists in defining the shortest and quickest path.

The article-receiving zone defined in the method may be of any type. For example, said zone may be constituted by a zone on a conveyor that conveys the articles to be taken hold of past the polyarticulated system. Said zone may also be stationary, and be constituted by a loose pile of articles to be extracted one-by-one.

When the article to be taken hold of is in a loose pile made up of a plurality of articles, the method may advantageously further comprise a step consisting in identifying the articles that are at the highest heights. The located specific zone may then be chosen from among the zones located on the article that is identified as being the highest.

In this way, the method avoids attempts to take hold of an article that is partially covered or overlapped by another article, and that has a reduced chance of being successfully taken hold of.

Advantageously, the method further comprises a step consisting firstly in checking whether the article has been taken hold of by the pick-up member, and secondly in choosing another located compatible specific zone when a determined number of unsuccessful attempts to take hold of the article have been made.

In this manner, the method cannot remain “stuck” on an article that the pick-up member is unable to take hold of. After a determined number of unsuccessful attempts to take hold of an article, the method goes automatically to another zone to be taken hold of, on the same article or on a different other article, using the same pick-up member or another pick-up member.

In a particular implementation, the step of the method consisting in identifying compatible specific zones of the articles to be taken hold of consists in identifying continuous zones when the pick-up member is of the suction cup type.

The term “suction cup” is used to mean both a suction cup operating with air being sucked up, and also a suction cup of the magnetic type, such as a magnet, for example. Naturally, to be compatible with the suction cup, the identified continuous region should have a continuous region comprising at least a minimum surface area corresponding to the active surface area of the suction cup.

In a particular implementation, the step of the method consisting in identifying compatible specific zones of the articles to be taken hold of consists in identifying preferably parallel edges or generator lines, when the pick-up member is of the clamp type. Naturally, in this configuration, and in order to be compatible with the clamp, the maximum spacing between said edges or generator lines must be less than the maximum possible spacing between the jaws of said clamp.

The invention also provides an installation for automatically picking up an article. The installation comprises a polyarticulated system associated with a vision system, and a zone suitable for receiving at least one article to be taken hold of. The polyarticulated system includes at least one pick-up member suitable for taking hold of an article via a specific zone of said article. The vision system is suitable for taking an image of the article-receiving zone.

In accordance with the invention, the vision system and the polyarticulated system are associated with processing and computation means suitable for processing the information resulting from the taken image, for identifying all of the specific zones that are present on the articles to be taken hold of, and that are compatible with the pick-up members, for locating, in position and in orientation, the identified compatible specific zones, and for automatically defining a pick path along which the corresponding pick-up member should take hold of the corresponding article via the chosen compatible specific zone.

This installation is thus suitable for implementing the method of the invention and, in this way, includes all of the above-mentioned advantages of said method.

In different implementations, the pick-up member of the polyarticulated system may include at least one clamp and/or at least one suction cup.

Advantageously, the pick-up member(s) is/are provided with elastically deformable members arranged at the portions of said pick-up members that are designed to come into contact with the article to be taken hold of. Said elastically deformable members behave flexibly so as to adapt to the type of the article to be taken hold of. Thus, a fragile article can be taken hold of without being broken.

### BRIEF DESCRIPTION OF THE DRAWINGS

Other characteristics and advantages of the invention appear clearly from the following description that is given below by way of non-limiting indication, with reference to the accompanying figures, in which:

FIG. 1 is a diagrammatic perspective view of an installation of the invention for automatically picking up an article;

FIG. 2 is a diagrammatic perspective view of the pick-up members of the polyarticulated system;

FIG. 3 is a diagrammatic perspective view of a pick-up member of the clamp type of the polyarticulated system; and

FIG. 4 is a diagrammatic perspective view of a pick-up member of the suction cup type of the polyarticulated system.

### DETAILED DESCRIPTION OF THE INVENTION

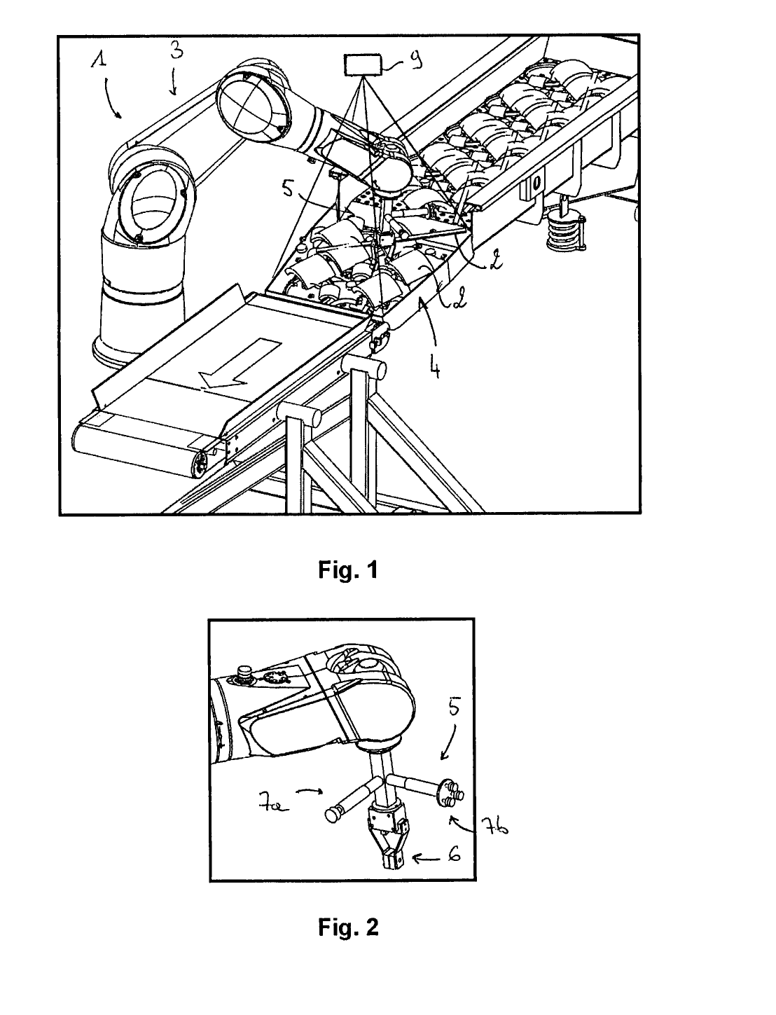

With reference to FIG. 1, an installation (1) of the invention for automatically picking up an article (2) includes a polyarticulated system (3) and an article-receiving zone (4).

The polyarticulated system (3) is, for example, a six-axis robot that is well known from the state of the art. Said polyarticulated system (3) is suitable for taking hold of an article (2) via a specific zone of said article (2). To this end, said polyarticulated system (3) includes three pick-up members (5), and is associated with a vision system (9).

The articles (2) to be taken hold of are disposed randomly in loose manner in the article-receiving zone (4). For example, the articles (2) are of different sizes, shapes, and types.

The article-receiving zone (4) that is shown is constituted by loose pile of articles (2) to be extracted one-by-one.

With reference to FIG. 2, the pick-up members (5) may be of any suitable type. The essential requirement is for them to be suitable for taking hold of an article (2) via a specific zone of said article (2). In the embodiment shown, the pick-up members (5) are in the form of a clamp (6), of a first suction cup (7a), and of a second suction cup (7b), both suction cups operating by suction.

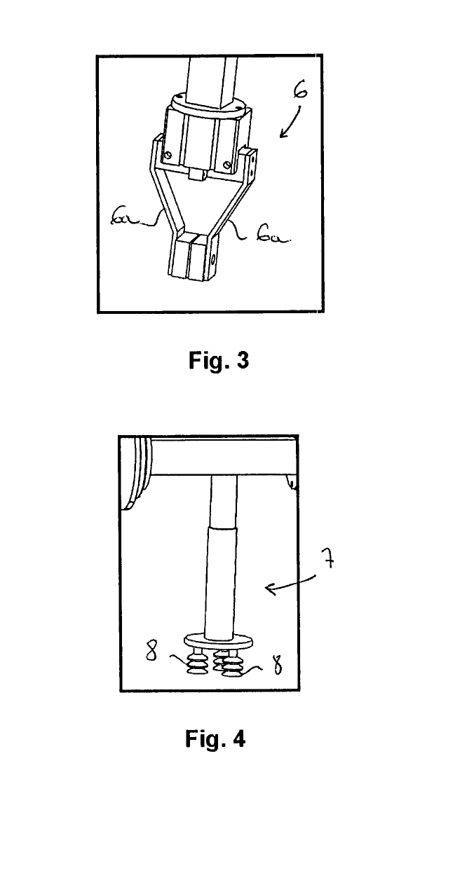

With reference to FIG. 3, the clamp (6) comprises two jaws (6a) suitable for moving apart and for coming together to take hold of an article (2). The specific zones of an article (2) that are suitable for being taken hold of by said clamp (6) are edges or generator lines that are preferably parallel. Naturally, the maximum spacing between said edges or generator lines must be less than the maximum possible spacing between the jaws (6a) of said clamp (6). On its portion designed to be in contact with the article (2) to be taken hold of, each of the jaws (6a) advantageously has an elastically deformable member (8) behaving flexibly so as to adapt to the type of said article (2) to be taken hold of.

With reference to FIG. 4, and in a manner that is well known from the state of the art, a suction cup (7) is associated with suction means. At its end, said suction cup (7) is provided with an elastically deformable member (8) in the form of a sleeve suitable for being applied to a specific zone of an article (2) to take hold of said article (2) by suction. The elastically deformable sleeve (8) is designed to make the contact with the article (2) to be taken hold of. The elastically deformable sleeve (8) has a first level of compliance or flexibility, in particular determined to adapt to a certain type of article (2) that is fragile. This sleeve (8) makes it possible to take hold of fragile articles (2) without breaking them.

The specific zones of an article (2) that can be taken hold of by a first suction cup (7) are continuous, i.e. they are surfaces that are substantially plane and of dimensions suitable for bearingly receiving said elastically deformable sleeve (8) of the suction cup (7).

The first and second suction cups (7a, 7b) are similar, except for their elastically deformable sleeves (8) that have different levels of compliance. For example, the second suction cup (7b) is larger than the first suction cup (7a) so as to be adapted to heavier and less fragile articles (2).

The vision system (9), which is preferably disposed in register with the article-receiving zone (4), is suitable for taking an image of the article-receiving zone (4), and may be of any suitable type, such as, for example, a 3D camera, or else a camera operating in stereo mode.

In addition, the installation (1) has processing and computation means associated with the polyarticulated system (3) and with the vision system (9).

Said processing and computation means are of any suitable type, and may, for example, be in the form of a microprocessor.

Said processing and computation means are suitable for processing the information resulting from the taken image in such a manner as to identify, on the articles (2) to be taken hold of, edges or generator lines that are preferably parallel and that are spaced apart by spacing less than the maximum spacing between the jaws (6a) of the clamp (6). They are also suitable for identifying, on the articles (2) to be taken hold of, plane surfaces whose dimensions are suitable for bearingly receiving the elastically deformable sleeves (8) of the first and section suction cups (7a, 7b).

Said processing and computation means also make it possible to locate, in position and in orientation, said identified compatible specific zones, and to choose one of the located compatible specific zones.

Choosing the zone to be taken hold of consists, for example, in weighting each identified zone with a coefficient that is a function of the probabilities of the zone being successfully taken hold of by the corresponding pick-up member (5), and in choosing the zone that has the highest probabilities of being successfully taken hold of. In practice, weighting coefficients are assigned for each identified and compatible zone, as a function of one or more parameters. The parameters used may be of any type such as, for example, the height of the zone to be taken hold of, the area of the visible surface, and the inclination of the zone to be taken hold of. Each zone to be taken hold of therefore has weighting for each of the chosen parameters. Then, an average is taken of each weighting of the zone to obtain a score. Depending on the type of the weighting, the zone having the highest score, or the lowest score is chosen to be taken hold of.

Once the specific zone has been chosen, which zone is, for example, a plane surface that can be taken hold of by one of the suction cups (7a, 7b), or indeed two parallel edges that can be taken hold of by the clamp (6), said processing and computation means are suitable for automatically defining a pick path along which the corresponding pick-up member should take hold of the corresponding article (2) via said chosen compatible specific zone. The installation (1) of the invention thus makes it possible to implement a method of automatically picking up an unknown article (2).

In accordance with the invention, the method comprises the steps consisting in:
taking an image of the article-receiving zone (4) by means of the vision system (9);
processing the information resulting from the image and identifying all of the specific zones that are present on the articles (2) to be taken hold of, and that are compatible with the pick-up member(s) (5);
locating, in position and in orientation, the identified compatible specific zone(s);
choosing one of the located compatible specific zones and automatically defining a pick path along which the corresponding pick-up member (5) should take hold of the corresponding article (2) via the chosen compatible specific zone; and
taking hold of the corresponding article (2) along the defined path.

This method is advantageous in that it makes it possible to take hold of any article (2) whatsoever, whatsoever without learning the article (2) or the pick path along which said article (2) should be taken hold of.

In accordance with the invention, one of the pick-up members (5) may be preferred over the others. An order of preference for use of the pick-up members (5) may be established.

If, the clamp (6) is given first preference, during the processing of the image taken by the vision system (9), one of the located specific zones is chosen only from among those that could be taken hold of with said clamp (6).

The method of the invention is advantageous because it makes it possible to separate to an initial extent loosely-disposed unknown articles (2) automatically and rapidly, without requiring the intervention of an operative, or prior learning of the article (2), or of the pick path along which the article (2) should be taken hold of.

Naturally, the method and the installation (1) of the invention may implement a plurality of polyarticulated systems (3), each of which may be associated with the same vision system (9), or indeed each of which may be associated with its own vision system (9). Thus, when one of the polyarticulated systems (3) moves an article (2) that has been taken hold of, another polyarticulated system (3) may, while said article (2) that has been taken hold of is being moved, take hold of another, and so on, thereby saving time. This makes it possible to perform pick and place operations for picking and placing unknown articles (2) optimally and quickly. After it has been taken hold of, the article (2) may be handled and processed in any desired manner, e.g. it can be conveyed to a processing station or indeed be placed in a specific article-receiving tray or bin.

1. A method of using a polyarticulated system associated with a vision system for automatically picking up an article situated in a zone suitable for receiving at least one article, said polyarticulated system including at least one pick-up member suitable for taking hold of an article via at least one specific zone of said article, said method comprising at least the steps of:
taking an image of the article-receiving zone with the vision system;
processing the information resulting from the image and identifying all of the specific zones that are present on the articles to be taken hold of, and that are compatible with the at least one pick-up members;
locating, in position and in orientation, the identified compatible at least one specific zones;
choosing one of the located compatible specific zones and automatically defining a pick path along which the corresponding pick-up member should take hold of the corresponding article via the chosen compatible specific zone; and
taking hold of the corresponding article along the defined path.

2. A method of automatically picking up an article according to claim 1, characterized in that the step of choosing one of the located compatible specific zones comprising of weighting each identified zone with a coefficient that is a function of probabilities of the zone being successfully taken hold of by the corresponding pick-up member, and choosing the zone that has the highest probabilities of being successfully taken hold of.

3. A method of automatically taking hold of an article according to claim 1, characterized in that the step of defining a pick path comprises defining a shortest and quickest path.

4. The method of automatically picking up an article according to claim 1, characterized in that the article to be taken hold of is in a loose pile of a plurality of different articles to be taken hold of.

5. The method of automatically picking up an article according to claim 4, characterized in that the method further comprises a step of identifying the articles that are at highest heights, and in that the located specific zone is chosen from among the zones located on the article that is identified as being the highest.

6. The method of automatically picking up an article according to claim 1, characterized in that the method further comprises a step comprising firstly checking whether the article has been taken hold of by the pick-up member, and, secondly, choosing another located compatible specific zone when a determined number of unsuccessful attempts to take hold of the article have been made.

7. The method of automatically picking up an article according to claim 1, characterized in that the step of identifying compatible specific zones of the articles to be taken hold of comprises identifying continuous zones when the pick-up member is of a suction cup type.

8. The method of automatically picking up an article according to claim 1, characterized in that the step of identifying compatible specific zones of the articles to be taken hold of comprises identifying edges or generator lines, when the pick-up member is of a clamp type, and wherein a maximum spacing between said edges or generator lines is less than a maximum possible spacing between the jaws of said clamp.

9. An installation for automatically picking up an article, said installation comprising a polyarticulated system associated with a vision system, and a zone suitable for receiving at least one article to be taken hold of, said polyarticulated system including at least one pick-up member suitable for taking hold of an article via at least one specific zone of said article, said vision system being suitable for taking an image of the article-receiving zone, said installation being characterized in that said vision system and said polyarticulated system are associated with processing and computation means suitable for processing the information resulting from the taken image, for identifying all of the specific zones that are present on the articles to be taken hold of, and that are compatible with the pick-up members, for locating, in position and in orientation, the identified compatible specific zones, and for automatically defining a pick path along which the corresponding pick-up member should take hold of the corresponding article via the chosen compatible specific zone.

10. The installation for automatically picking up an article according to claim 9, characterized in that the pick-up member of the polyarticulated system is in the form of at least one clamp.

11. The installation for automatically picking up an article according to claim 9, characterized in that the pick-up member of the polyarticulated system is in the form of at least one suction cup.

12. The installation for automatically picking up an article according to claim 9, characterized in that the pick-up member(s) is/are provided with elastically deformable members arranged at the portions of said pick-up members that are designed to come into contact with the article to be taken hold of, said elastically deformable members behaving flexibly so as to adapt to the type of the article to be taken hold of.
